(19) United States
(12) Patent Application Publication
(10) Pub. No.: US 2011/0145724 A1
(43) Pub. Date: Jun. 16, 2011

(54) Multi-Screen Electronic Device and Reference Material Display Method Thereof

(75) Inventors: Chuan-Ming TSAI, Hsichih (TW); Tzu-Lung CHUANG, Sijhih City (TW); Chueh-Pin KO, Taipei City (TW)

(73) Assignee: ACER INCORPORATED, Hsichih (TW)

(21) Appl. No.: 12/769,815

(22) Filed: Apr. 29, 2010

(30) Foreign Application Priority Data
Dec. 15, 2009 (TW) 098143004

(51) Int. Cl. G06F 15/16; G06F 17/30; G06F 3/048

(52) U.S. Cl. 715/748; 707/E17.108; 709/217; 707/706; 715/776; 715/761

(57) ABSTRACT

A multi-screen electronic device includes a first screen, a second screen, a storage unit, and a central processing unit electrically connected to the first and second screens and the storage unit. Also, a reference material display method applied to the multi-screen electronic device includes the steps of opening an e-book file stored in the storage unit and displaying contents of the e-book file on the first screen of the multi-screen electronic device; searching for a predetermined mark that is shown on the first screen; transmitting the predetermined mark to a predetermined website; and displaying contents sent back from the predetermined website on the second screen of the multi-screen electronic device. Thus, the reference material display method allows a user to read the e-book file compactly.

### FIELD OF THE INVENTION

The present invention relates to an electronic device and a material display method thereof; and more particularly, to a multi-screen electronic device and a reference material display method thereof.

### BACKGROUND OF THE INVENTION

As the development and popularization of personal electronic information products, e-reader has been widely adopted by the general public. Now, more and more users start reading an e-book instead of reading physical books.

In addition, since the e-reader has the advantage of storing many e-books therein, a user using the e-reader does not need to carry a lot of heavy and thick physical books around. Therefore, more and more users would read an e-reader when they are waiting for bus or taking a public transport or in any short leisure time.

FIG. 1A is a block diagram of a conventional e-reader, and FIG. 1B is an exemplified front view of the e-reader according to FIG. 1A. Please refer to FIGS. 1A and 1B, the conventional e-reader 100 includes a screen 110, a storage unit 120, and a central processing unit (CPU) 130. The CPU 130 is electrically connected to the screen 110 and the storage unit 120.

The storage unit 120 stores a plurality of e-book files stored therein. When the CPU 130 has opened one of the e-book files, contents of the e-book file is displayed on the screen 110 for users to read, as shown in FIG. 1B.

In the course of reading the e-book, the user would generally mark some specific parts of the e-book file as M1, and use these marks M1 as keywords to search further related information.

However, when the user wants to conduct the search, the user must first exit the contents of the e-book file currently displayed on the screen 110, and then switch to a search website and enter the mark M1 to search for related reference materials. When the user wants to continue the reading of the e-book file again, the user must first exit the search website and switch back to the contents of the e-book file.

According to the aforementioned searching method, the user has to repeatedly switch between different contents displayed on the screen 110. Such a repeated switching operation not only brings confusion to the user, but also interrupts the reading continuity to largely reduce the reading efficiency.

Sometimes, it is possible the user might want to compare the contents of the e-book file with the related information obtained according to the marks M1 at the same time, so as to more quickly comprehend or to fully memorize the contents of the e-book file. Unfortunately, the conventional e-reader 110 fails to fulfill these requirements.

Moreover, the user would also frequently want to know other users' reviews on the e-book file from some book review websites while the user is reading the e-book file. According to the aforementioned conventional e-reader 100, the user still has to repeatedly switch among different contents on the screen 110, which causes inconveniences to read the e-book file.

### SUMMARY OF THE INVENTION

Due to the drawbacks of the conventional e-books, a primary object of the present invention is providing a reference material display method that allows a user to read contents of an e-book file and to obtain further materials in connection with a predetermined mark without switching between different windows.

Another object of the present invention is providing a multi-screen electronic device that allows a user to read contents of an e-book file and to obtain related reviews on the e-book file without switching between different windows.

To achieve the above or other objects, a reference material display method in accordance with the present invention is applied to a multi-screen electronic device and includes the following steps: opening an e-book file and displaying contents of the e-book file on a first screen of the multi-screen electronic device; searching for a predetermined mark displayed on the first screen; transmitting the predetermined mark to a predetermined website; and displaying contents sent back from the predetermined website on a second screen of the multi-screen electronic device.

After the step of displaying the contents of the e-book file on the first screen, the following step is further included: determining the aforementioned predetermined mark on the first screen by a user.

The predetermined marks may be more than one. Also, the predetermined marks include a first predetermined mark and a second predetermined mark, and the second screen may display a first option and a second option corresponding to the first and the second predetermined mark, respectively. Besides, the second screen displays the contents, which are corresponding to the first predetermined mark and sent back from the predetermined website. Further, when the user clicks to select the second option, the second screen will display contents, which are corresponding to the second predetermined mark and sent back from the predetermined website.

To achieve the above or other objects, a multi-screen electronic device according to the present invention includes a first screen; a second screen; a storage unit; and a central processing unit (CPU) electrically connected to the first screen, the second screen, and the storage unit. The CPU opens an e-book file stored in the storage unit and displays contents of the e-book file on the first screen. The CPU also searches for a predetermined mark shown on the first screen, and transmits the predetermined mark to a predetermined website. Moreover, the CPU further displays contents sent back from the predetermined website on the second screen.

The predetermined mark on the first screen is further determined by a user when the contents of the e-book file has been displayed on the first screen of the multi-screen electronic device.

The predetermined mark may be more than one. Also, the predetermined marks include a first predetermined mark and a second predetermined mark, and the second screen may display a first option and a second option corresponding to the first and the second predetermined mark, respectively. Besides, the second screen will display the contents corresponding to the first predetermined mark and sent back from the predetermined website. Further, when the user clicks to select the second option, the second screen will display contents, which are corresponding to the second predetermined mark and sent back from the predetermined website.

To achieve the above or other objects, a reference material display method according to the present invention applied to a multi-screen electronic device includes the following steps: opening an e-book file, retrieving basic information about the e-book file, and displaying contents of the e-book file on a first screen of the multi-screen electronic device; transmitting the basic information to a predetermined website; and displaying contents sent back from the predetermined website on a second screen of the multi-screen electronic device.

The predetermined website may be a book review website, and the basic information may be, for example, a name, an International Standard Book Number (ISBN), an Amazon Standard Item Number (ASIN), an author, or a publisher of the e-book file.

The contents sent back from the book review website may include reviews on the e-book file, and a CPU of the multi-screen electronic device may transmit users' review on the e-book file to the book review website.

A multi-screen electronic device according to the present invention includes a first screen; a second screen; a storage unit; and a central processing unit (CPU) electrically connected to the first screen, the second screen, and the storage unit. The CPU opens an e-book file stored in the storage unit, retrieves basic information about the e-book file, and displays contents of the e-book file on the first screen. The CPU also transmits the basic information to a predetermined website, and displays contents sent back from the predetermined website on the second screen.

The predetermined website may be a book review website, and the basic information may be a name, an International Standard Book Number (ISBN), an Amazon Standard Item Number (ASIN), an author, or a publisher of the e-book file.

The contents sent back from the book review website may include reviews on the e-book file, and the CPU may further transmit the user's review on the e-book file to the book review web site.

In brief, with the multi-screen electronic device and the reference material display method thereof in accordance with the present invention, the predetermined mark displayed on the first screen is automatically searched, and contents corresponding to the predetermined mark sent back from the predetermined search website is directly displayed on the second screen, so that a user is able to get desired reference materials without repeatedly switching between different contents on the screen. Thus, the user can read the e-book file smoothly.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiment of the present invention will be understood more fully from the detailed description given below and from the accompanying drawings of various embodiments of the invention, which, however, should not be taken to limit the invention to the specific embodiments, but are for explanation and understanding only.

FIG. 1A is a block diagram of a conventional e-reader;

FIG. 1B is a schematic front view of the conventional e-reader according to FIG. 1A;

FIG. 2A is a block diagram of the first embodiment of a multi-screen electronic device according to the present invention;

FIG. 2B is a schematic front view of the multi-screen electronic device according to FIG. 2A;

FIG. 3 is a flowchart showing the steps according to another embodiment of a reference material display method in the present invention;

FIGS. 4A and 4B are another two schematic front views of the multi-screen electronic device according to FIG. 2A;

FIG. 5A is a block diagram of another embodiment of the multi-screen electronic device according to the present invention;

FIG. 5B is a schematic front view of the multi-screen electronic device according to FIG. 5A; and

FIG. 6 is a flowchart showing the steps included in an embodiment of the reference material display method according to the present invention.

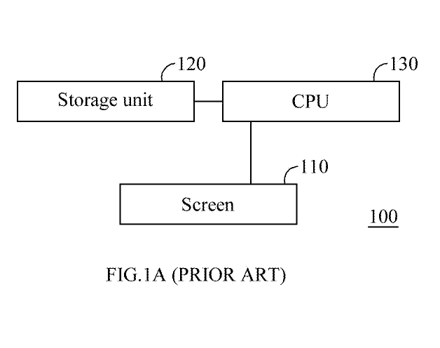

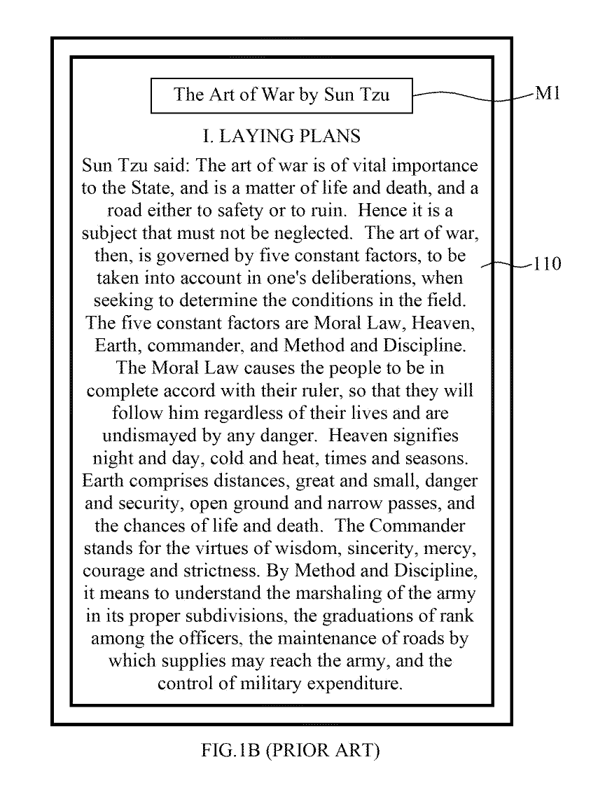

### DETAILED DESCRIPTION OF THE PREFERRED EMBODIMENTS

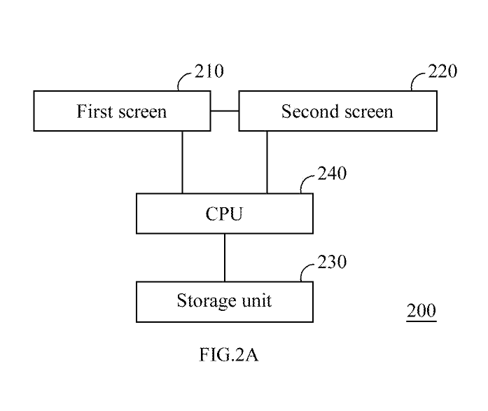

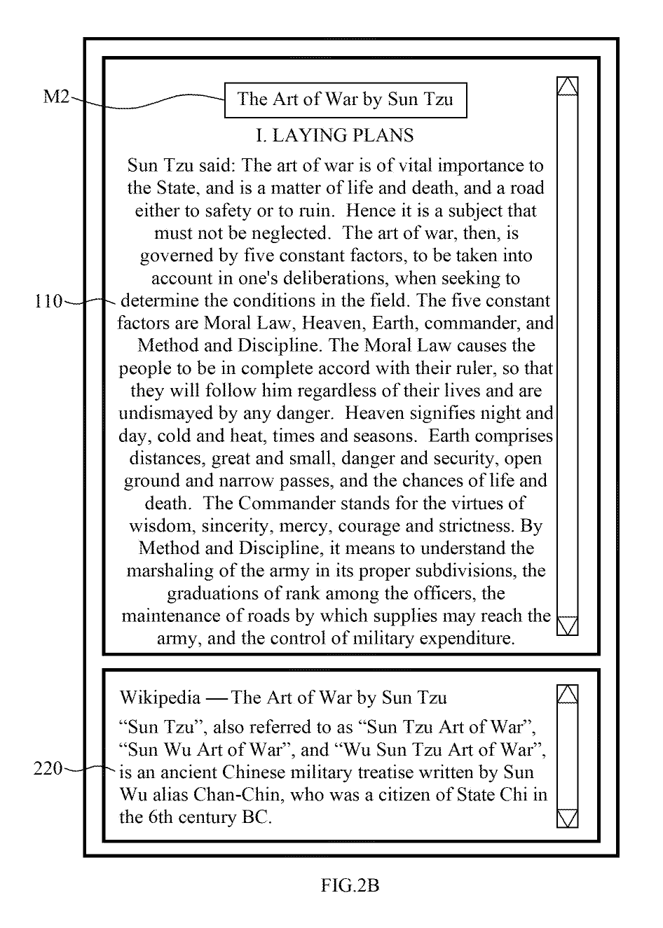

FIG. 2A is a block diagram of the first embodiment of a multi-screen electronic device 200 according to the present invention, and FIG. 2B is a schematic front view of the multi-screen electronic device 200 according to FIG. 2A. Please refer to FIGS. 2A and 2B. The multi-screen electronic device 200 according to the first embodiment thereof includes a first screen 210, a second screen 220, a storage unit 230, and a central processing unit (CPU) 240. The CPU 240 is electrically connected to the first screen 210, the second screen 220, and the storage unit 230.

The storage unit 230 may be a hard disk, a solid state disk, a compact disk, or other suitable storage media for storing e-book files therein. When a user clicks to select one of the e-book files, the CPU 240 will open the selected e-book file and display contents of the e-book file on the first screen 210 for the user to read, as shown in FIG. 2B.

During the continuously browsing process that the user reading the contents of the e-book, if a predetermined mark M2 is shown on the first screen 210 and the predetermined mark M2 is detected by the CPU 240, the CPU 240 will automatically transmit the predetermined mark M2 to a predetermine website by background operation. When the predetermined website sends any contents regarding the predetermined mark M2 back to the CPU 240, the contents transmitted back to the CPU 240 will be display on the second screen 220.

In the exemplified contents shown on the first screen 210, the predetermined mark M2 is “The Art of War by Sun Tzu”, and the predetermined website is, for example, Wikipedia. Thus, reference materials related to “The Art of War by Sun Tzu” are shown on the second screen 220 for the user's reference.

In this manner, the user is able to automatically obtain further materials corresponding to the predetermined mark M2 without repeatedly switching between different contents on the screen, and the user may read the e-book file in a highly smooth and convenient manner.

In addition, with the multi-screen electronic device 200, the contents shown on the first screen and 210 the second screen 220 may be cross-compared to allow the user better understand materials corresponding to the predetermined mark M2, and accordingly, better understand the contents of the e-book file. As a result, the reading quality can be improved.

In the illustrated first embodiment, a specific portion of the contents will be marked as the predetermined mark M2 when the user is reading the e-book file, so that the CPU 240 displays materials corresponding to the predetermined mark M2 on the second screen 220 for users' reference.

Further, later when the user opens the same e-book file again and browses a page having contents containing the predetermined mark M2, the predetermined mark M2 will be shown on the first screen 210, and at this point, the CPU 240 will also automatically show reference materials corresponding to the predetermined mark M2 on the second screen 220 by background operation.

In the illustrated first embodiment, the predetermined mark M2 is determined by the user in the course of reading the e-book file. However, the present invention is not limited to a specific manner of selecting the predetermined mark M2. For example, in the process of producing the e-book file, a manufacturer may display some important contents of the e-book file as predetermined marks M2 and links the predetermined marks M2 to a predetermined website, so that the CPU 240 would directly show the related contents from the predetermined website on the second screen 220. That is, the predetermined mark M2 may be some specific website information, and the predetermined website may be a website corresponding to the specific website information.

Other than a website corresponding to the predetermined mark M2 as mentioned above, the predetermined website may also be a website with search engines, such as Google, Wikipedia, Yahoo, Baidu or other suitable websites.

Please refer to FIGS. 2A and 2B again. The first embodiment of the multi-screen electronic device 200 is a dual-screen e-reader. However, according to the present invention, there is not any specific restriction to the types of the multi-screen electronic device 200 and to the number of the screens. In addition, the e-book file may have a format of PDF, DOC, HTML, TXT, CHM or other suitable file formats; and the contents of the e-book file may include the contents of general books, technical documents, periodicals, magazines, etc. According to the present invention, there is not any specific restriction to the format and the contents of the e-book file.

While the above description has already explained how reference materials are displayed in the first embodiment of the multi-screen electronic device 200, a reference material display method according to another embodiment of the present invention is now further described in details with a flowchart. Thus, the present invention will become more apparent to users.

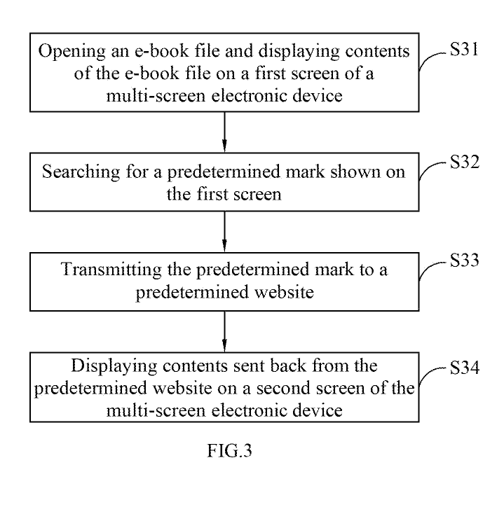

FIG. 3 is a flowchart showing the steps according to another embodiment of the reference material display method in the present invention. Please refer to FIG. 3, the reference material display method according to an embodiment of the present invention may be applied to a multi-screen electronic device having a first screen and a second screen, such as the multi-screen electronic device 200 shown in FIG. 2A. However, it is understood the reference material display method in this embodiment is not limited to use with the aforementioned multi-screen electronic device 200.

First, as shown in the step S31, an e-book file is opened, so that contents of the e-book file are shown on the first screen for a user to read.

Besides, according to the first embodiment of the multi-screen electronic device 200, the e-book file is stored in the storage unit 230 and is opened by the CPU 240. However, as one of ordinary skill in the art can easily understood, in the reference material display method according to the present invention, the e-book file may be opened and stored in other manners without any specific restriction thereto. For the purpose of conciseness and clarity, the following description will not repeat the difference between the multi-screen electronic device applied to the reference material display method of the present embodiment and the first embodiment of the multi-screen electronic device 200.

As shown in step S32, a predetermined mark displayed on the first screen is searched. For example, the predetermined mark will be shown when a user displays some specific contents of the e-book file as a predetermined mark in the course of reading, or when a manufacturer displays some important contents of the e-book file as a predetermined mark in the process of producing the e-book file.

Thereafter, as shown in step S33, the predetermined mark is transmitted to a predetermined website. The predetermined website may be a search website as mentioned above or a website to which the predetermined mark is directly corresponding. Further, the predetermined mark may be transmitted by linking to the Internet through cable or wireless transmission.

Finally, as shown in step S34, the contents sent back from the predetermined website are displayed on the second screen of the multi-screen electronic device. Thus, the user can directly cross-reference the contents on the first and the second screen. In this manner, the user can read the e-book file in a highly convenient manner.

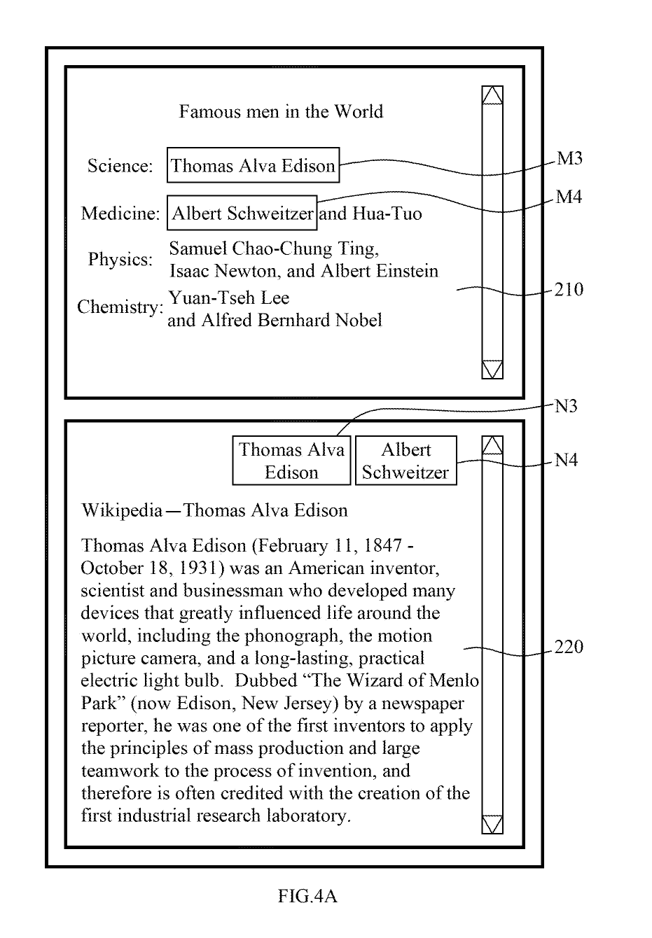

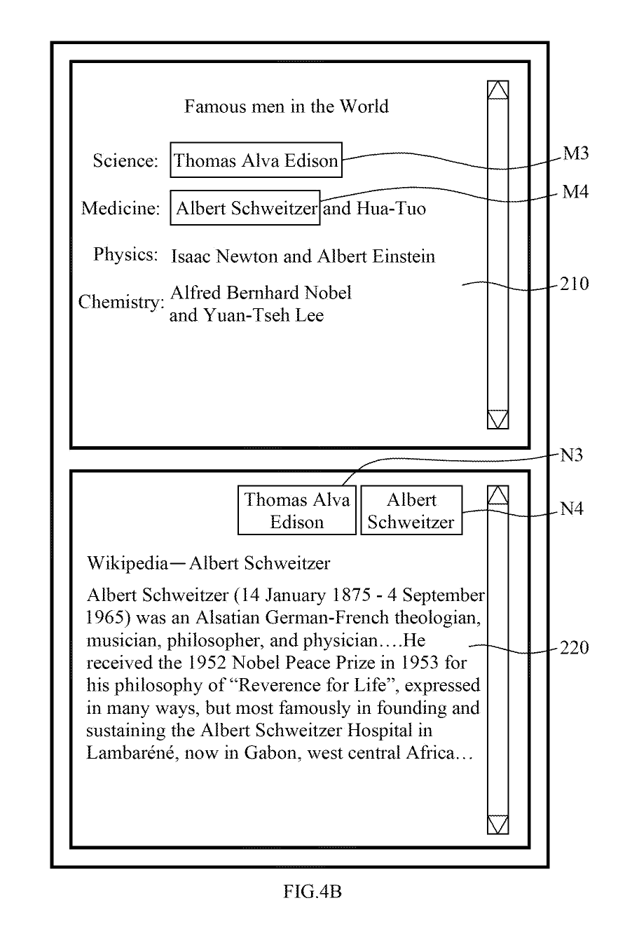

In some cases, it is possible two or more predetermined marks are shown on the first screen, and following with reference to FIGS. 4A and 4B will describe a method of handling two predetermined marks. However, it is understood that one of ordinary skill in the art can carry out changes and modifications in the described method based on the following interpretation.

FIG. 4A is an schematic front view of a multi-screen electronic device according to FIG. 2A, and the difference between FIG. 4B and FIG. 2B is the contents shown on the first and the second screen. Please refer to FIG. 4A, a plurality of predetermined marks may be shown on the first screen 210. For example, these predetermined marks may be respectively marked as a first predetermined mark M3 and a second predetermined mark M4. On the other hand, a first option N3 and a second option N4 are shown on the second screen 220. The first option N3 corresponds to the first predetermined mark M3, and the second option N4 corresponds to the second predetermined mark M4.

The CPU 240 automatically transmits the first predetermined mark M3 and the second predetermined mark M4 to the predetermined website by background operation. In a default condition, the contents corresponding to the first predetermined mark M3 will be sent back from the predetermined website and displayed on the second screen 220 first.

Accordingly, when it is desired to obtain reference materials related to the second predetermined mark M4, users only need to click the second option N4 and contents corresponding to the second predetermined mark M4 and sent back from the predetermined website are shown on the second screen 220, as shown in FIG. 4B.

When it is desired to obtain the reference materials related to the first predetermined mark M3 again, the users only need to click the first option N3, and the contents corresponding to the first predetermined mark M3 and sent back from the predetermined website would be shown on the second screen 220 again, as shown in FIG. 4A.

However, the present invention is not necessarily to handle these predetermined marks by using option tabs in the case of two or more predetermined marks on the first screen 210, For example, the present invention may split the second screen 220 to display the reference materials related to the first predetermined mark M3 and the second predetermined mark M4 simultaneously, allowing the user to obtain more reference materials at one time.

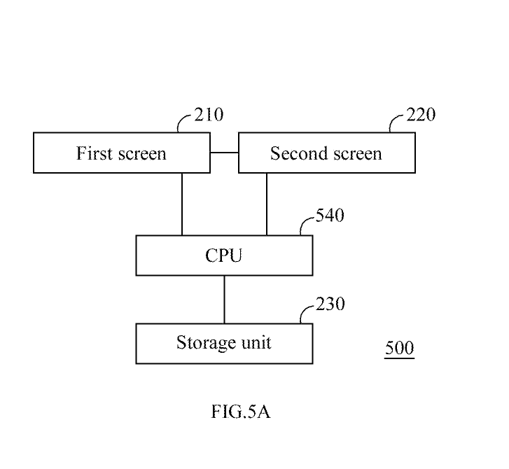

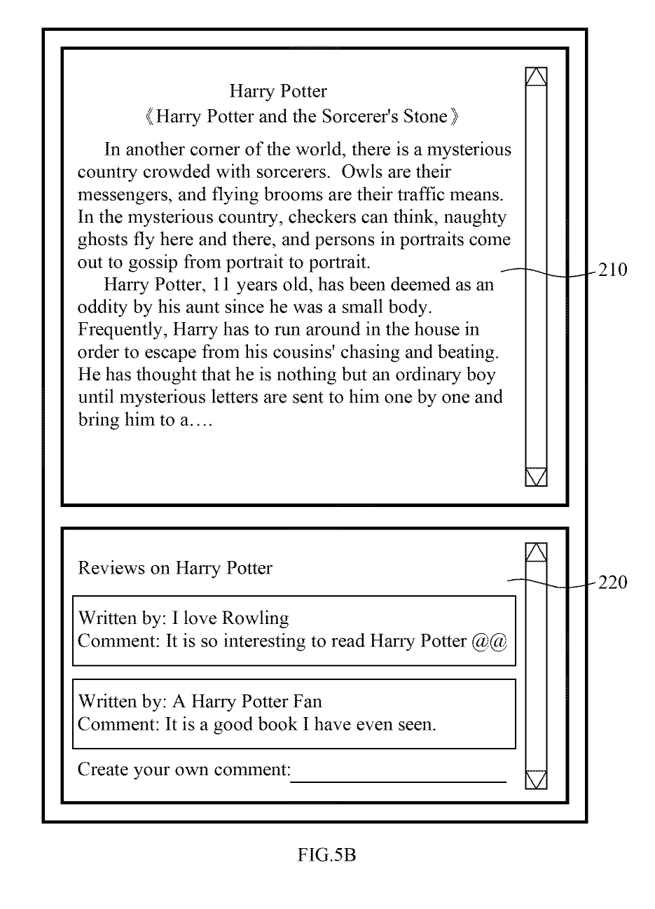

It is noted the user might want to know other users' reviews on the same e-book file read by the user. For the user to read the e-book file in a more convenient manner, another embodiment of the multi-screen electronic device according to the present invention will now be described with reference to FIGS. 5A and 5B. The same reference indicators are still used throughout the following description to refer to the same or like parts for convenience.

FIG. 5A is a block diagram of an embodiment of the multi-screen electronic device 500 according to the present invention, and FIG. 5B is a schematic front view of the multi-screen electronic device 500 according to FIG. 5A. Please refer to FIGS. 5A and 5B. Generally, the multi-screen electronic device 500 in this embodiment is similar to the multi-screen electronic device 200 in the embodiment as shown in FIG. 2A, except for a CPU 540 that works different from that of the CPU 240.

When the user clicks to select certain e-book file on the multi-screen electronic device 500, the CPU 540 will retrieve basic information about the selected e-book file and open the e-book file at the same time, so that contents of the e-book file are displayed on the first screen 210 for the user to read, as shown in FIG. 5B.

Then, the CPU 540 automatically transmits the basic information to a predetermined website by background operation. When the predetermined website sends back contents in connection with the basic information, the CPU 540 will display the returned contents on the second screen 220, as shown in FIG. 5B.

In the illustrated second embodiment, the basic information may be, for example, the name, the International Standard Book Number (ISBN), the Amazon Standard Item number (ASIN), the author, or the publisher of the e-book file, or other information corresponding to the e-book file. In an e-book file under copyright protection, the basic information thereof is stored in a specific format at a specific field address and is accessible by the CPU 540.

Further, the predetermined website may be a book review website, such as aNobii, LibraryThing, or other suitable websites. When the basic information of the e-book file is received, the book review website will search a database thereof for reviews on the e-book file and send the contents of book reviews back to the CPU 540.

In this manner, the user can obtain other users' comments of the e-book file directly on the second screen 220 without repeatedly switching between different contents on the screen of an electronic device. Furthermore, the user can also directly enter his or her review in the “Create Your Own Review” field on the second screen 220 when the user has any gain from reading the e-book file. The CPU 540 will then transmit the user's review to the book review website for sharing the same with other readers immediately.

In the present invention, the predetermined website is not limited to the book review website but may be other similar websites, such as a forum website, or a website determined by the user.

While the above description has also explained how reference materials are displayed on the multi-screen electronic device 500, the reference material display method according to the present invention is now further described in details with reference to a flowchart thereof, so that the present invention will become apparent to the user from such description.

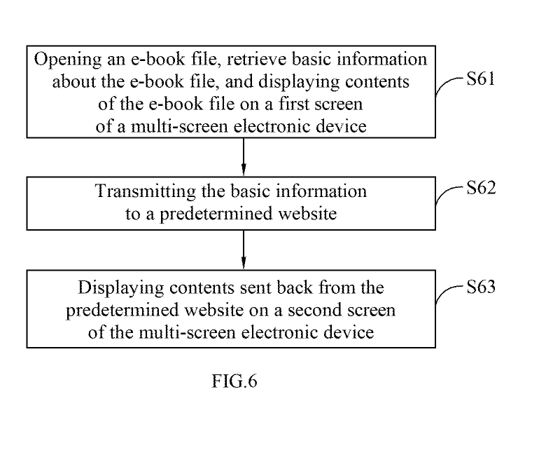

FIG. 6 is a flowchart showing the steps of the reference material display method according to the present invention. Please refer to FIG. 6, the reference material display method may be applied to a multi-screen electronic device having a first screen and a second screen, such as the multi-screen electronic device 500 shown in FIG. 5A. However, it is understood the reference material display method is not limited to use only with the aforementioned multi-screen electronic device 500.

First, as shown in the step S61, an e-book file is opened and basic information about the e-book file is retrieved, and meanwhile, contents of the e-book file are shown on the first screen of the multi-screen electronic device for a user to read.

Then, as shown in step S62, the basic information is transmitted to a predetermined website. The predetermined website may be a book review website, a forum website, or a website entered by the user.

Finally, as shown in step S63, contents sent back from the predetermined website is displayed on the second screen of the multi-screen electronic device. The contents sent back from the predetermined website may include book reviews on the e-book file read by the user, so that the user can automatically obtain other users' reviews on the e-book file when the user is reading the contents of the e-book file.

It is understood that readers can combine the embodiments of the present invention by referring to the above description without departing from the scope of the present invention. For example, reviews in connection with the e-book file may be displayed on the second screen when there is not any predetermined mark shown on the first screen; Also, reference materials corresponding to a predetermined mark may be displayed on the second screen when the predetermined mark is shown on the first screen. Since such combination of different embodiments can be easily understood by one ordinary skilled in the art, it is skipped herein.

In brief, the multi-screen electronic device and the reference material display method according to the present invention provide at least the following advantages:

(1) By automatically searching the predetermined mark displayed on the first screen and displaying reference materials corresponding to the predetermined mark on the second screen, the present invention allows a user to obtain desired reference materials without the need of repeatedly switching between different contents on the screen. Thus, the user can read the e-book file in a highly smooth and convenient manner.

(2) By automatically retrieving the basic information about the e-book file and displaying related contents, such as other users' reviews on the e-book file, on the second screen, the present invention allows the user not only to obtain related information in connection with the e-book file, but also to make a response to the contents of the e-book file directly. For example, the user can give his or her review on the e-book file.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A reference material display method applied to a multi-screen electronic device, comprising the following steps:
opening an e-book file and displaying contents of the e-book file on a first screen of the multi-screen electronic device;
searching for a predetermined mark displayed on the first screen;
transmitting the predetermined mark to a predetermined website; and
displaying contents sent back from the predetermined website on a second screen of the multi-screen electronic device.

2. The reference material display method as claimed in claim 1, wherein the predetermined website is a website with search engines.

3. The reference material display method as claimed in claim 1, wherein a user is determining a predetermined mark on the first screen when the contents of the e-book file are displayed on the first screen.

4. The reference material display method as claimed in claim 1, wherein a plurality of the predetermined marks are on the first screen, the plurality of the predetermined marks comprise a first predetermined mark and a second predetermined mark, the second screen displays a first option corresponding to the first predetermined mark, the second screen displays a second option corresponding to the second predetermined mark, and the second screen displays contents corresponding to the first predetermined mark sent back from the predetermined website.

5. The reference material display method as claimed in claim 4, wherein the second screen is displaying contents corresponding to the second predetermined mark sent back from the predetermined website when a user clicks to select the second option.

6. A multi-screen electronic device, comprising:
a first screen disposed on the multi-screen electronic device;
a second screen disposed on the multi-screen electronic device and displaying contents corresponding to a predetermined mark shown on the first screen;
a storage unit disposed in the multi-screen electronic device and storing an e-book file; and
a central processing unit (CPU) electrically connected to the first screen, the second screen, and the storage unit;
wherein the CPU opens the e-book file stored in the storage unit and displays contents of the e-book file on the first screen; the CPU also searches for the predetermined mark shown on the first screen, and transmits the predetermined mark to a predetermined website; and the CPU further displays contents sent back from the predetermined website on the second screen.

7. The multi-screen electronic device as claimed in claim 6, wherein the predetermined website is a website with search engines.

8. The multi-screen electronic device as claimed in claim 6, wherein the predetermined mark on the first screen is determined by a user.

9. The multi-screen electronic device as claimed in claim 6, wherein a plurality of the predetermined mark are on the first screen, the plurality of the predetermined marks comprise a first predetermined mark and a second predetermined mark, the second screen displays a first option corresponding to the first predetermined mark, the second screen displays a second option corresponding to the second predetermined mark, and the second screen displays the contents corresponding to the first predetermined mark sent back from the predetermined website.

10. The multi-screen electronic device as claimed in claim 9, wherein the second screen is displaying contents corresponding to the second predetermined mark sent back from the predetermined website when a user clicks to select the second option.

11. A reference material display method applied to a multi-screen electronic device, comprising the following steps:
opening an e-book file;
retrieving basic information about the e-book file;
displaying contents of the e-book file on a first screen of the multi-screen electronic device;
transmitting the basic information to a predetermined website; and
displaying contents sent back from the predetermined website on a second screen of the multi-screen electronic device.

12. The reference material display method as claimed in claim 11, wherein the predetermined website is a book review website.

13. The reference material display method as claimed in claim 12, wherein the contents sent back from the book review website comprise reviews on the e-book file.

14. The reference material display method as claimed in claim 13, further comprising a step of transmitting a user's review on the e-book file to the book review website.

15. The reference material display method as claimed in claim 11, wherein the basic information comprises a name, an International Standard Book Number (ISBN), an Amazon Standard Item number (ASIN), an author, or a publisher of the e-book file.

16. A multi-screen electronic device, comprising:
a first screen disposed on the multi-screen electronic device;
a second screen disposed on the multi-screen electronic device and displaying contents corresponding to a predetermined mark shown on the first screen;
a storage unit disposed in the multi-screen electronic device and storing an e-book file; and
a central processing unit (CPU) electrically connected to the first screen, the second screen, and the storage unit;
wherein the CPU opens the e-book file stored in the storage unit, retrieves basic information of the e-book file, and displays contents of the e-book file on the first screen; and the CPU also transmits the basic information to a predetermined website and displays contents sent back from the predetermined website on the second screen.

17. The multi-screen electronic device as claimed in claim 16, wherein the predetermined website is a book review website.

18. The multi-screen electronic device as claimed in claim 17, wherein the contents sent back from the book review website comprise reviews on the e-book file.

19. The multi-screen electronic device as claimed in claim 18, wherein the CPU transmits a user's review on the e-book file to the book review website.

20. The multi-screen electronic device as claimed in claim 16, wherein the basic information comprises a name, an International Standard Book Number (ISBN), an Amazon Standard Item number (ASIN), an author, or a publisher of the e-book file.
